(19) United States
(12) Patent Application Publication
(10) Pub. No.: US 2026/0186816 A1
(43) Pub. Date: Jul. 2, 2026

(54) VIRTUAL MACHINE DELETION INCIDENT CREATION AND WORKFLOW

(71) Applicant: Dell Products L.P., Round Rock, TX (US)

(72) Inventors: SAKSHI GARG, Faridabad (IN); PARMESHWR PRASAD, Bangalore (IN); FRANCIS WILFRED NIJAY, Chennai (IN)

(21) Appl. No.: 19/006,943

(22) Filed: Dec. 31, 2024

(51) Int. Cl. G06F 9/455

(52) U.S. Cl. CPC G06F 9/45558; G06F 2009/45562

(57) ABSTRACT

Methods and systems for managing virtual machines (VMs) are disclosed. Powered-off VMs that still exist on hardware resources of a data processing system may unnecessarily tie up limited computing resources of the data processing system. Identification and deletion of these powered-off VMs while also considering a degree of importance of each of these powered-off VMs advantageously frees up the unnecessarily tied up limited computing resources while also ensuring that powered-off yet important VMs are not inadvertently deleted.

### FIELD

Embodiments disclosed herein relate generally to memory device access control. More particularly, embodiments disclosed herein relate to systems and methods to manage access to one or more memory devices by abstracted resources hosted by a data processing system (e.g., a computing device).

### BACKGROUND

Computing devices may provide computer implemented services. The computer implemented services may be used by users of the computing devices and/or devices operably connected to the computing devices. The computer implemented services may be performed with hardware components such as processors, memory modules, storage devices, and communication devices. The operation of these components and the components of other devices may impact the performance of the computer implemented services.

### BRIEF DESCRIPTION OF THE DRAWINGS

Embodiments disclosed herein are illustrated by way of example and not limitation in the figures of the accompanying drawings in which like references indicate similar elements.

FIG. 1A shows a block diagram illustrating a system in accordance with one or more embodiments.

FIG. 1B shows a block diagram illustrating a data processing system in accordance with one or more embodiments.

FIG. 2 shows a data flow diagram in accordance with one or more embodiments.

FIG. 3 shows a flowchart in accordance with one or more embodiments.

FIG. 4 shows a block diagram illustrating a computing device in accordance with one or more embodiments.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing virtual machines (VMs). In particular, multiple VMs can be spined (e.g., instantiated, created, etc.) across hardware (e.g., a computing device). Because VMs allow numerous programs (e.g., computer programs, software, applications, or the like) to operate on shared hardware while also providing resource separation and increased security VMs have become critical components of cloud systems and/or other types of distributed network environments.

However, VMs are resource intensive and consume a substantial amount of space on the hardware of the device (e.g., computing device) on which the VMs are hosted (e.g., instantiated, created, or the like). In particular, VMs are very memory intensive and computing devices usually have limited memory resources as well as other types of computing resources (e.g., limited processing availability, limited power rating, etc.). Once a device's limited memory resources are depleted (e.g., all being allocated and used by VMs and other processes and/or components executing on the device including a VM orchestrator such as a hypervisor or the like), new VMs cannot be created, existing VMs may also stop responding, and other native processes (e.g., default operating system processes) may also stop responding or slow down resulting in a negative impact on the functionalities (e.g., computing functionalities) of the host device.

Not all created VMs are constantly active. For example, some VMs may be shutdown (e.g., powered-off) when not in use. These VM, although powered-off/shutdown, may still exist and take up limited computing resources (e.g., memory, processing resources including central processing unit (CPU) and/or graphical processing unit (GPU) resources, or the like) of the host device. Only by deleting these shutdown/powered-off VMs (referred to herein from this point on as “powered-off VMs”) from the host hardware will these limited computing resources be freed up. Said another way, unless these powered-off VMs are deleted, the functionalities of the host device may continually be negatively impacted by the existence of these powered-off VMs. For example, a host device may host six VMs that are all powered-off for a prolonged period of time. These six VMs, even when powered-off, still take up a majority of the host device's limited computing resources causing other processes on the host device to be negatively affected (e.g., causing other processes to be completed in a much slower manner, causing the processes to stop or crash due to not enough limited computing resources being available, etc.).

Additionally, some licenses (e.g., software licenses or the like) are tied to active usage of a VM. Keeping a VM off (e.g., shutdown/powered-off) for an extended time could lead to non-compliance with one or more clauses, agreements, and/or rules specified in such licenses. Entities that create VMs on hardware and/or other resources provided by other entities may also be charged for the hardware and/or other resources used by these VMs. Thus, VMs that are in a prolonged off (e.g., shutdown/powered-off) state may incur unnecessary and unintended costs for these entities. Even further, if a VM contains sensitive (e.g., confidential) data or applications, prolonged inactivity (e.g., in the off state) can increase the VM's vulnerabilities to security threats since new and updated security patches may not be applied while the VM is in the off state.

However, deletion of these powered-off VMs require extensive and tedious manual inspection of each powered-off VM to ensure that these powered-off VMs are not actually important VMs (e.g., created for a high-level executive of a company, associated with running programs and services that multiple other services require, or the like) that could cause unwanted negative downstream and/or upstream effects when deleted. Such manual inspection could not be practically done simply using pen, paper, and the human mind as hundreds and up to hundreds of thousands of these VMs may need to be manually inspected each day (or at even shorter time intervals based on one or more set policies and/or preferences).

To overcome the above-discussed limitations of using VMs, embodiments disclosed herein provide systems and methods for managing these VMs using an incident workflow that advantageously identifies (e.g., in an automated manner) powered-off VMs that can be deleted without causing any (or minimal to inconsequential) unwanted negative downstream and/or upstream effects.

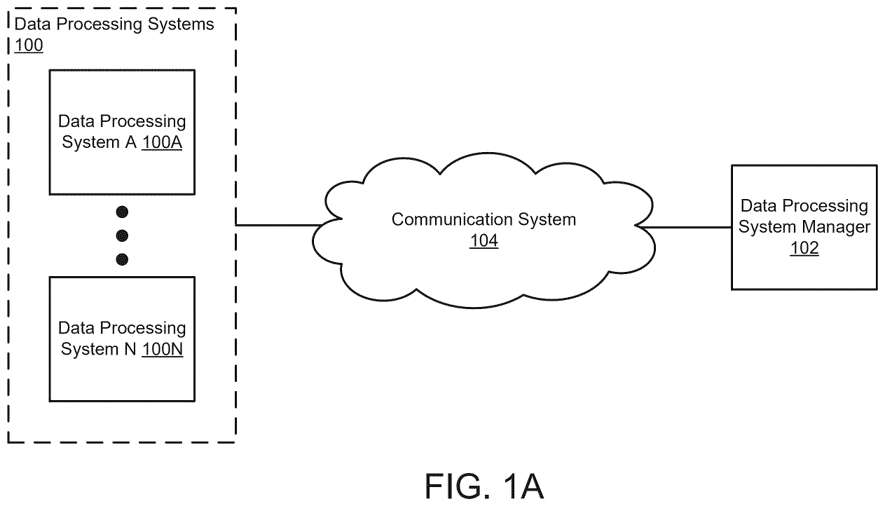

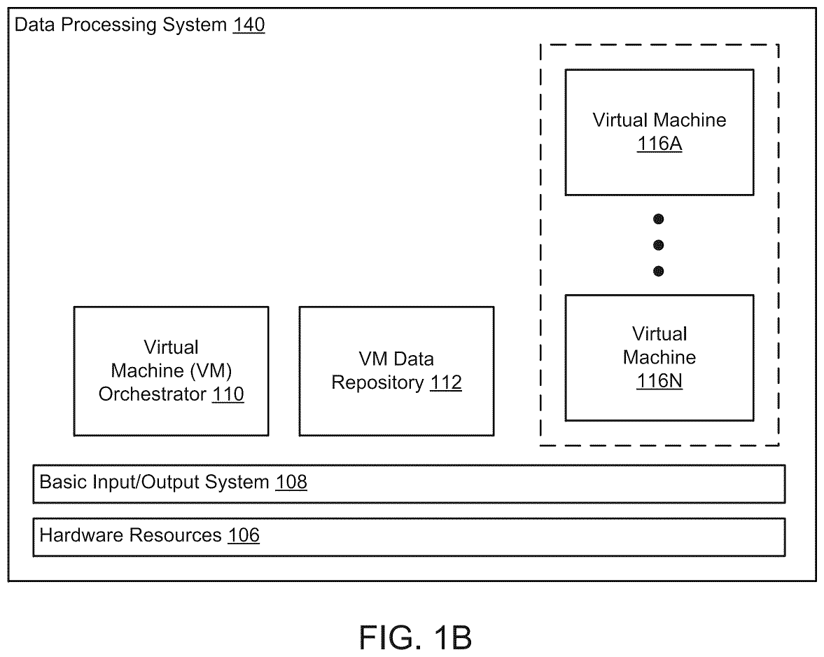

In particular, a fully automated workflow may be provided to determine, without user intervention, an importance of each powered-off VM. Such importance of each powered-off VM may be based on various operating characteristics and properties (to be discussed in more detail below) of each powered-off VM. Such importance of each powered-off VM may also be used to generate (e.g., using one or more machine learning models and machine learning-based techniques) a deletion score for each powered-off VM. The generated deletion score may then be utilized by the host device and/or a separate computing system managing the host device (e.g., the data processing system manager 102 of FIG. 1A) to create one or more incidents/incident workflows to cause deletion of one or more of these powered-off VMs.

Said another way, embodiments disclosed herein may be directed to a VM state and importance management system that identifies (e.g., in a fully and/or partially automatic manner) powered-off VMs that are not importance within the distributed network environment (e.g., the VM orchestration environment). Once identified, the unimportant powered-off VMs may be automatically deleted without needing any user involvement to provide advantages to the user including: (1) improving the computer functionalities (e.g., through freeing up limited computing resources tied up by the unimportant powered-off VM) of the host device that hosted the powered-off VM; (2) providing increased security to sensitive data and/or applications of the user by removing any prolonged powered-off VM that are now more prone to security threats; (3) providing cost savings and licensure compliance for users that use VMs hosted by other entities; and/or any other improvements and advantages associated with the resolution of any of the above-discussed limitations of using VMs.

As a result, embodiments disclosed herein not only provide an improvement to computer-related technology (e.g., technologies associated with VM hosting and usage) but also provide direct improvements to the computing functionalities of the devices (e.g., computing devices) that are hosting these VMs (namely, the powered-off VMs).

In an embodiment, a method for managing virtual machines (VMs) may include: obtaining VM data associated with the VMs; using the VM data to identify one or more VM deletion candidates; performing a VM importance determination process to identify at least one to-be-deleted-VM from among the one or more VM deletion candidates; generating an incident ticket for starting deletion of the at least one to-be-deleted-VM; and causing, based on the incident ticket, a data processing system hosting the at least one to-be-deleted-VM to delete the at least one to-be-deleted-VM from the data processing system.

The one or more VM deletion candidates are powered-off VMs that are still hosted on and take up limited computing resources of the data processing system despite being in a shutdown state.

The one or more VM deletion candidates are powered-off VMs that have been in the shutdown state for over a predetermined shutdown time threshold.

Performing the VM importance determination process may include: generating a VM deletion score for each of the one or more VM deletion candidates, the VM deletion score being based on a degree of importance of each of the one or more VM deletion candidates.

The may be an inference generated a combination of machine learning based techniques comprising bagging, boosting, and stacking.

The degree of importance is based on an entity to which a VM deletion candidate among the one or more VM deletion candidates is assigned.

The degree of importance is further based on a time of creation of the VM deletion candidate.

The degree of importance is further based on a determination of whether the VM deletion candidate is a development VM or a production VM.

The degree of importance is further based on a technology purpose for which the VM deletion candidate is being used.

The deleting of the at least one to-be-deleted-VM is completed without taking a snapshot of the at least one to-be-deleted-VM during or before the deleting.

The method is performed by a data processing system manager that manages a plurality of the data processing system where each of the plurality of the data processing system hosts one or more of the VMs, and the method being performed by the data processing system manager fully automatically without any intervention by any users of the data processing system manager and any users of the plurality of the data processing system.

The method may further include: obtaining, from the data processing system and in response to the data processing system being caused to delete the at least one to-be-deleted-VM, a VM deletion failure notification indicating that deletion of the at least one to-be-deleted-VM has failed and requires manual intervention by a user; and forwarding the VM deletion failure notification to the user to request manual deletion by the user.

A non-transitory media may include instructions that when executed by at least a processor of a data processing system cause the computer-implemented method to be performed by the data processing system.

A data processing system may include the non-transitory media and a processor, and may perform the computer-implemented method when processor executes the instructions in the non-transitory media.

Turning to FIG. 1A, a block diagram illustrating a system in accordance with an embodiment is shown. The system shown in FIG. 1A may provide computer implemented services. The computer implemented services may include any type and quantity of computer implemented services. For example, the computer implemented services may include data storage services, instant messaging services, database services, virtual machine instantiation and usage services, and/or any other type of service that may be implemented with a computing device.

To provide the above noted functionality, the system of FIG. 1A may include any number of data processing systems 100 (e.g., data processing systems 100A-100N). Data processing systems 100 may provide the computer implemented services to users of data processing systems 100 and/or to other devices (not shown). Different data processing systems may provide similar and/or different computer implemented services.

To provide the computer implemented services, data processing systems 100 may include various hardware components (e.g., processors, memory modules, storage devices, etc.) and host various software components (e.g., operating systems, application, startup managers such as basic input-output systems, etc.). These hardware and software components (discussed in more detail below in FIG. 1B) may provide the computer implemented services via their operation.

The software components may be implemented using various types of services. For example, each data processing system of the data processing systems 100 may host various services that provide the computer implemented service (e.g., application services, virtual machine related services) and/or services that manage the operation of these services (e.g., management services). The aggregate (e.g., combination) of the management and application services may be a complete service that provide desired functionalities.

To manage the data processing systems 100, the system of FIG. 1A may include data processing system manager 102. Data processing system manager 102 may include various hardware components (e.g., processors, memory modules, storage devices, etc.) and host various software components (e.g., operating systems, application, startup managers such as basic input-output systems, etc.). These hardware and software components may provide the functionalities (e.g., the communication with and management of the data processing systems) of the data processing system manager 102.

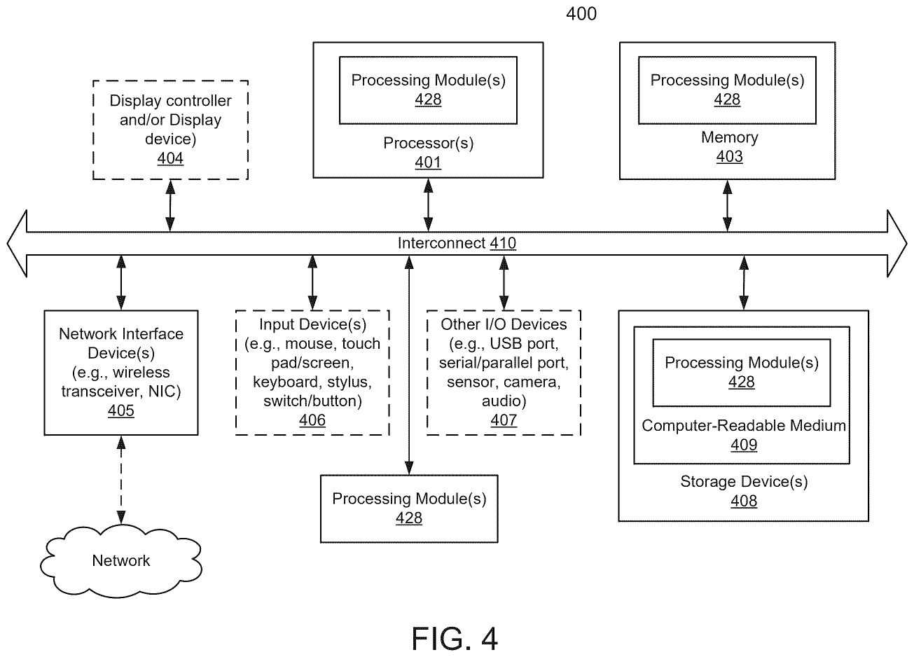

In one example, the data processing system manager 102 may be a computing device (e.g., computing device of FIG. 4) such as a desktop computer or server that is used by used by manufacturers (or distributors, administrators, etc.) of one or more components installed within the data processing systems 100 to communicate with and manage (namely, the components installed within) the data processing systems 100.

Any of the components illustrated in FIG. 1A may be operably connected to each other (and/or components not illustrated) with communication system 104. In an embodiment, communication system 104 includes one or more networks that facilitate communication between any number of components. The networks may include wired networks and/or wireless networks (e.g., and/or the Internet). The networks may operate in accordance with any number and types of communication protocols (e.g., such as the Internet Protocol).

While FIG. 1A is illustrated as including a limited number of specific components, a system in accordance with an embodiment may include fewer, additional, and/or different components than those illustrated therein.

Turning to FIG. 1B, a diagram illustrating data processing system 140 in accordance with an embodiment is shown. Data processing system 140 may be similar to any of the data processing systems 100 and/or data processing system manager 102 shown in FIG. 1A.

To provide computer implemented services, data processing system 140 may include any quantity of hardware resources 106. Hardware resources 106 may include physical parts of data processing system 140 that store and run software. Hardware resources 106 may include processors, memory modules (also referred to herein as “memory devices”), storage devices, and/or other types of hardware components usable to provide computer implemented services. A basic input/output system (BIOS) 108 may be stored on the processors and memory modules.

BIOS 108 may be used to startup data processing system 140. On the startup, BIOS 108 may configure peripheral devices, such as a keyboard, mouse, monitor, etc. With the peripheral devices, BIOS 108 may configure hardware resources 106 for use by data processing system 140.

Virtual machine (VM) orchestrator 110 may include software, hardware, and/or a combination thereof (e.g., a hypervisor or the like) that enables operation of virtual machines 116A-116N on data processing system 140. Each of virtual machines 116A-116N may host an operating system and one or more applications. Upon operation of virtual machines 116A-116N, VM orchestrator 110 may allocate limited computing resources (e.g., storage space in a memory device of the data processing system 140, blocks of the data processing system's CPU or GPU, or the like) to each of virtual machines 116A-116N from hardware resources 106.

VM data repository 112 may be used by data processing system 140 to store data (e.g., operation, identity, and/or other types of data such as property and/or characteristics data) associated with each of the VMs 116A-116N. VM data repository 112 may be embodied (e.g., implemented) using any type of physical and/or virtual storage (e.g., hard disk drive, solid state drive, etc.) made up by one or more storages making up hardware resources 106 of the data processing system 140.

While FIG. 1B is illustrated as including a limited number of specific components, a data processing system in accordance with an embodiment may include fewer, additional, and/or different components than those illustrated therein. For example, in addition to all of the components shown in FIG. 1B, the data processing system 140 may also include part of all of the components of the example computing device described below in reference to FIG. 4.

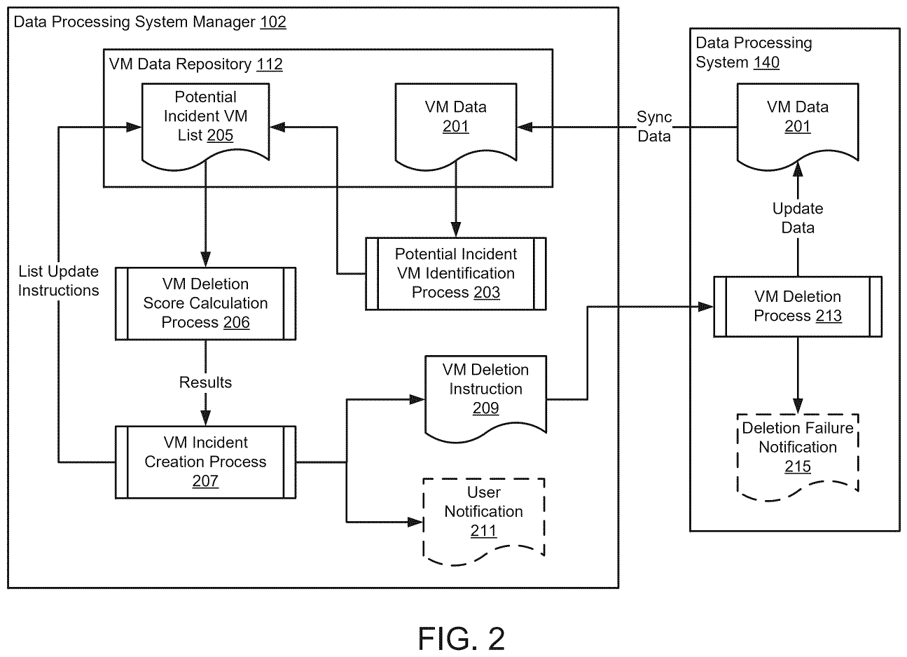

To further clarify embodiments disclosed herein, a data flow diagram in accordance with an embodiment are shown in FIG. 2. In this diagram, flows of data and processing of data are illustrated using different sets of shapes. A first set of shapes (e.g., 201, 209, 211, 215, etc.) is used to represent data structures (e.g., files, documents, data packets, or the like), a second set of shapes (e.g., 203, 205, 207, 213 etc.) is used to represent processes performed using and/or that generate data, and a third set of shapes (e.g., 140, 102, 112, etc.) is used to components and/or devices that perform (e.g., execute) the processes shown using the second set of shapes.

The data flow diagram of FIG. 2 may be performed by any of the components (e.g., any of the data processing systems 100A-100N and the data processing system manager 102 of FIG. 1A). In the description below, the data flow diagram of FIG. 2 will be discussed as being performed by a data processing system (e.g., 140) in combination with a data processing system manager 102. Although the data processing system manager 102 is described in FIG. 2 as interacting with only a single data processing system (e.g., 140), in embodiments, the data processing system manager may interact with any number of data processing system (e.g., two or more, or all, of the data processing systems 110A-110N shown in FIG. 1A) without departing from the scope of embodiments disclosed herein.

As shown in FIG. 2, a data processing system 140 may have VM data 201. VM data 201 may include any type of data associated with one or more VMs (e.g., VMs 116A-116N of FIG. 1B) that are hosted on data processing system 140. For example, VM data 201 may include, but is not limited to: VM name, description state, status, host, provisioned space, used space, active memory, memory size, uptime, etc. Other types of data, some of which may be discussed below, that can be used to understand any aspect of the VMs (e.g., operation, identify, property, characteristic, etc.) not listed above may also be collected as part of VM data 201 without departing from the scope of embodiments disclosed herein.

In embodiments, VM data may be collected by, for example, VM orchestrator 110 of data processing system 140 and/or any other component (e.g., any of the hardware resources 106 and/or BIOS 108 of the data processing system 140 as shown in FIG. 1B). The data processing system 140 may be configured (e.g., programmed) to collect the VM data 201 based on a VM data collection policy set by a user and/or administrator of data processing system 140.

The VM data collection policy may be based on any type of rules (e.g., business rules, security rules, data management rules, etc.) set by the user and/or administrator and may specify, for example: (i) how often the VM data 201 should be collected within a certain time interval (e.g., one hour, one day, one week, one month, one year, or the like); (ii) what data should be collected; (iii) a specific time within a day or date within a year that the VM data 201 should be collected; and/or any other similar or applicable data collection criteria and factors.

In embodiments, the VM data collection policy may be provided to the data processing system 140 by data processing system manager 102. For example, the VM data collection policy may be provided as data collection instructions from the data processing system manager 102. More specifically, based on one or more similar and/or identical VM data collection policies set in the data processing system manager 102, the data processing system manager 102 may fetch the VM data 201 (e.g., in the form of an application programming interface (API) call, or the like) from the data processing system 140. In embodiments, in response to the data collection instructions from the data processing system manager 102, the data processing system 140 (namely, the VMs 116A-116N and/or VM orchestrator 110 of the data processing system 140) may collect and/or send the VM data 201 to the data processing system manager 102 using techniques and/or protocols such as, but not limited to: vSphere; Kernel-based Virtual Machine (KVM); and/or Xen.

In embodiments, the data collection instructions from the data processing system manager 102 to the data processing system 140 may be part of a VM data 201 synchronization process to synch the VM data 201 into a storage (e.g., a VM data repository 112 which could be substantially similar and/or identical to the VM data repository 112 of data processing system 140 shown in FIG. 1B, an non-limiting example of which may be a configuration management database (CMBD) table or tables) of the data processing system manager 102. Similar to how the timing of the collection of the VM data 201 is affected by a VM data collection policy applied to data processing system 140, the data collection instructions from the data processing system manager 102 may be sent by the data processing system manager 102 at a timing based on a similar VM data collection policy applied to the data processing system manager 102.

Said another way, a VM data collection policy applied to the data processing system manager 102 may dictate how or when the VM data 201 should be fetched (e.g., synced) to the data processing system manager 102. For example, this sync cycle of the VM data 201 may be repeated every day (or at any other specified intervals). Each data processing system (e.g., 100A-100N) being managed by the data processing system manager 102 may be caused to sync their respective VM data 201 with the data processing system manager 102 using the same or different sync cycle.

Once the VM data 201 has been obtained (e.g., fetched, retrieved, synced, or the like) from data processing system 140 and stored into VM data repository 112 of data processing system manager 102, the data processing system manager 102 may use the VM data 201 into potential incident VM identification process 203 to identify one or more potential incident VMs among the VMs hosted on data processing system 140.

As part of VM identification process 203, one or more types of VMs may be identified based on one or more sets of rules and/or criteria applied by a user and/or administrator of the data processing system manager 102. For example, in one example embodiment, powered-off VMs are identified using VM data 201. The definition of what constitutes a powered-off VM may also be defined by the user and/or administrator of the data processing system manager 102. For example, but not to limit embodiments disclosed herein, any VM determined (e.g., after a current sync but before the next sync of the VM data, or the like) to be powered-off for at least 24 hours (or exceeding a predetermined shutdown time threshold or the like) may be considered powered-off VMs. As another example, a VM that has been in the off state (e.g., powered-off/shutdown state) during every sync (e.g., of VM data 201) continuously over any required number of days (as specified in the predetermined shutdown time threshold or the like) may be defined as a powered-off VM. Any other applicable and/or appropriate criteria and/or set of rules may be used to define what a powered-off VM is without departing from the scope of embodiments disclosed herein.

Strating from this point of this disclosure, powered-off VMs will be used the specific example for the one or more potential incident VMs identified using potential incident VM identification. However, as noted above, any other types of VMs may be identified as the one or more potential incident VMs based on one or more sets of rules and/or criteria applied by a user and/or administrator of the data processing system manager 102 without departing from the scope of embodiments disclosed herein.

In embodiments, the one or more potential incident VMs may be VMs for which incident tickets and/or workflows may be generated for potential deletion of these VMs. In particular, in embodiments, the one or more potential incident VMs may also be referred to one or more VM deletion candidates.

In embodiments, the one or more VM deletion candidates/one or more potential incident VMs identified using potential incident VM identification process 203 and VM data 201 may be stored in a potential incident VM list 205. The potential incident VM list 205 may be another CMBD table (or the like) stored in VM data repository 112 of data processing system manager 102. In embodiments, the data processing system manager 102 may update potential incident VM list 205 after each time new VM data 201 is stored into VM data repository 112 (e.g., after each sync of the VM data 201 with data processing system 140).

Once obtained, potential incident VM list 205 may be ingested into VM deletion score calculation process 206, which may be (or be a part of) a VM importance determination process 206 of embodiments disclosed herein. In embodiments, the data processing system manager 102 may be configured (e.g., programmed) to execute (e.g., perform) VM importance determination process 206 at least one time a day, or at any other time interval specified by a user and/or administrator of the data processing system manager 102.

In embodiments, as part of VM deletion score calculation process 206, a deletion score may be generated (e.g., calculated) for each VM deletion candidate included in potential VM list 205. The deletion score may be based, for example, on a degree of importance of each of the one or more VM deletion candidates. The deletion score may also be based on any other type of criteria and/or rules without departing from the scope of embodiments disclosed herein.

In embodiments, one or more criterions on which the degree of importance may be based includes, but is not limited to: (i) to whom a VM is assigned or for whom a VM is created; (ii) a time of creation of the VM; (iii) technology pillar(s) associated with the VM; (iv) a type of the VM; or the like. For example, a VM (e.g., a VM deletion candidate) may be deemed to be important if the VM is assigned to a high or higher ranking executive (e.g., a senior Vice President, a director or above, or the like) of an entity. In embodiments, such VMs assigned to a high or higher ranking executive may be automatically excluded from deletion (or may require manual/semi-automatic confirmation by a user prior to deletion).

As another example, based on the time of creation criterion, if a VM deletion candidate was determined to be created just a week before a significant event (e.g., a product release end, or the like) may be marked as having higher importance and be excluded from deletion.

As yet another example, based on the technology pillar criterion, data/logs associated with a VM deletion candidate may be scanned to identify a technology purpose for which the VM was used. Certain technology purposes associated with specific technology pillars (e.g., storage, application testing, or the like) may be afforded higher importance than other technology purposes.

As yet another example, based on the type of the VM criterion, a type of the VM deletion candidate may be assessed. For example, the VM deletion candidate may be assessed to determine whether the VM deletion candidate is a development VM or a production VM, the latter of which will be afforded more importance than the former and be protected from deletion.

In embodiments, the degree of importance in combination with any of the above-discussed criterion and/or any other data associated with the VM deletion candidates included in the VM data 201 may be used to generate (e.g., calculate) a deletion score for each of the one or more VM deletion candidates.

The VM deletion score may be an inference generated using a combination of machine learning based techniques comprising bagging, boosting, and stacking. For example, in one example embodiment, a dataset may be created using any data associated with each of the VM deletion candidates included in VM data 201 (e.g., data associated with each of the above-discussed criteria of to whom a VM is assigned or for whom a VM is created, time of creation of the VM, technology pillar(s) associated with the VM, type of the VM, or the like). These criteria may be used as input values of the dataset while historic (e.g., past) data regarding previous VM deletions may be used as output values for the dataset. This dataset (e.g., the entire set of input and output values forming the dataset) may form a training dataset (D). Additionally, testing data may also be obtained. The testing data may include data associated with powered-off VMs that have not been deleted and permitted to continue to exist (e.g., be hosted) on data processing system 140.

Using the training dataset (D) and testing data, bagging may be used where training dataset (D) is sampled with replacement and subdivided into at least two sub-sets (e.g., subsets d1, d2, d3, d4 . . . dn). In embodiments, replacement may mean that the same data point within the training dataset (D) may be selected multiple times within a single bootstrap sample of the bagging process. A trained or untrained machine learning model (M) may be applied on each (e.g., all) of the subdivided sub-sets (and the testing data) and a prediction for each subdivided sub-set (e.g., d1, d2, d3, d4 . . . dn) may be combined in form of an output of the bagging process.

In embodiments, the booting process may be used where the training dataset (D) is passed through different classifiers (m1 through mn). For example, training dataset (D) may be fed through classifier 1 (m1) to obtain prediction d′, which may in turn be fed through subsequent classifier 2 (m2) to obtain prediction d″ and so on until a final prediction dn (e.g., the output of the booting process) is obtained using classifier n (mn) (where n can be any whole number greater than 0). Each classifier (m1 through mn) may be a machine learning model.

In embodiments, as part of the stacking process, once trained on training dataset (D) (and the testing data), each machine learning model (e.g., from the boosting and/or bagging process) may be stacked such that predictions generated by each model may be used to create a new set of meta-features. In embodiments, the new set of meta-features may capture unique attributes of each data point within the training dataset (D) (and/or the testing data). These meta-features may be fed into a final meta-model (e.g., a final machine learning model) that merges original data features along with the new meta-features to obtain a final output (e.g., a deletion score) for each of the VM deletion candidates included in the potential incident VM list 205.

Although a specific example is discussed above using the combination of bagging, boosting, and stacking techniques/processes, the deletion score of embodiments disclosed herein may be generated (e.g., calculated) using any other type and/or combination of machine learning based techniques and processes without departing from the scope of embodiments disclosed herein.

In embodiments, the deletion score for each of the VM deletion candidates included in the potential incident VM list 205 may be ingested into VM incident creation process 207. As part of VM incident creation process 207, the data processing system manager 102 may evaluate (e.g., assess) each deletion score to determine which of the VM deletion candidates should actually be deleted. For example, deletion score exceeding a pre-defined deletion threshold may indicate that a VM deletion candidate is actually to be deleted.

As further part of VM incident creation process 207, an incident ticket and/or incident workflow may be created for each VM that is to be deleted (e.g., each “to-be-deleted-VM”). Each to-be-deleted VM may be removed from the potential incident VM list 205 while all of the non-to-be-deleted VMs within the VM deletion candidates are retained in the potential incident VM list 205 until the potential incident VM list 205 is updated (e.g. refreshed) after the sync of the VM data 201 from the data processing system 140.

As part of creating the incident ticket and/or incident workflow for each to-be-deleted-VMs, a VM deletion instruction 209 may be generated for each to-be-deleted-VM and an incident event may be logged in one or more data logs of the data processing system manager 102. A user notification 211 may also (optionally, as depicted by the broken lines in FIG. 2) be generated for each created incident ticket and/or incident workflow to inform one or more users associated with the to-be-deleted-VM that the VM is set up for automatic deletion.

In embodiments, the VM deletion instruction 209 for each to-be-deleted-VM may include instructions that would cause (e.g., when executed and/or performed by) the data processing system 140 to delete a VM (e.g., 116A-116N of FIG. 1B) corresponding to the to-be-deleted-VM. In particular, data processing system manager 102 may transmit (e.g., provide) all of the VM deletion instructions 209 generated as part of VM incident creation process 207 to data processing system 140, where the VM deletion instruction(s) 209 will be executed by data processing system 140 as part of VM deletion process 213.

As part of VM deletion process 213, the data processing system 140 may initialize (e.g., begin) deletion of VMs corresponding to the to-be-deleted-VMs specified in the VM deletion instruction(s) 209 obtained from data processing system manager 102. In embodiments, users (and/or administrators) associated with the to-be-deleted-VMs, the data processing system 140, and/or the data processing system manager 102 may specify (e.g., add) one or more custom workflows to handle the deletion of one or more to-be-deleted-VMs. These one or more custom workflows may be prestored in any of the data processing system manager 102 or the data processing system 140 and, in the former situation, may be provided to the data processing system 140 along with VM deletion instruction(s) 209.

In embodiments, to complete VM deletion process 213, all of the to-be-deleted VMs specified in the VM deletion instruction(s) 209 obtained by the data processing system 140 will be deleted (e.g., based on the one or more custom workflows if one if available). In embodiments, as part of the VM deletion process 213, one or more snapshots of the to-be-deleted-VMs will not be obtained and saved.

Additionally, in the event that the data processing system 140 is unable (or any multitude of reasons) to automatically delete a to-be-deleted-VM (i.e., if the deletion of a to-be-deleted-VM is unsuccessful), the data processing system 140 may generate a deletion failure notification 215 to notify a user (e.g., a human) to request manual intervention (e.g., manual deletion) of the to-be-deleted-VM by the user.

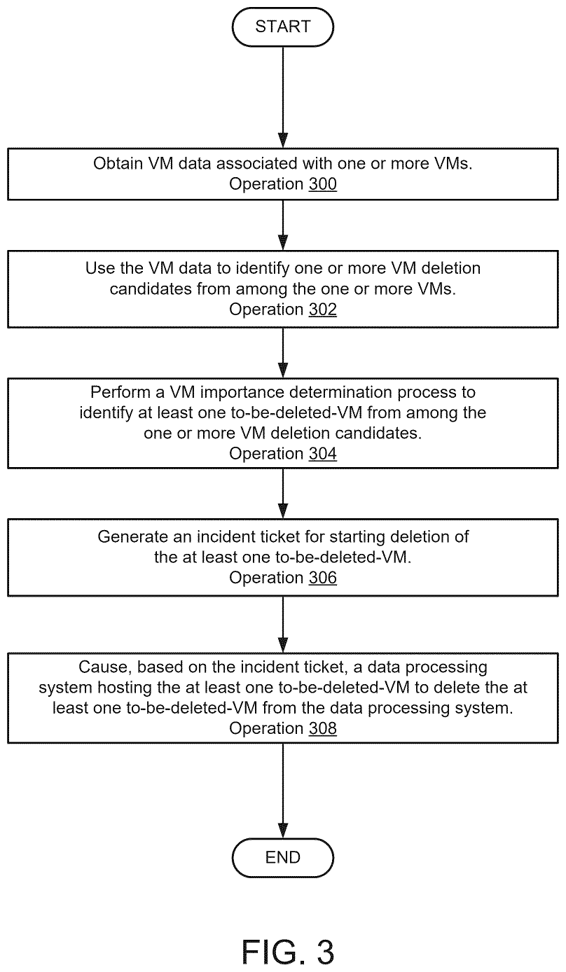

As discussed above, the components of FIGS. 1A-2 may perform various methods for managing VMs hosted by one or more data processing systems. FIG. 3 illustrates an example of a method that may be performed by the components of FIGS. 1A-2. For example, any of the data processing systems 100 and/or the data processing system manager 102 may perform all or a portion of the methods. In the diagrams discussed below and shown in FIG. 3, any of the operations may be repeated, performed in different orders, and/or performed in parallel with or in a partially overlapping in time manner with other operations.

Starting with FIG. 3, in Operation 300 and as discussed above in reference to FIG. 2, VM data associated with one or more VMs may be obtained (e.g., from one or more computing devices that are currently hosting the one or more VMs on their respective hardware resources).

In Operation 302, and as discussed above in reference to FIG. 2 (e.g., as part of potential incident VM identification process 203 of FIG. 2), the VM data may be used to identify one or more VM deletion candidates from among the one or more VMs. In embodiments, the one or more VM deletion candidates may be stored in a data structure such as a list or table (e.g., potential incident VM list 205 of FIG. 2).

In Operation 304, and as discussed above in reference to FIG. 2 (e.g., as part of VM deletion score calculation process 206 of FIG. 2), a VM importance determination process may be performed to identify at least one to-be-deleted-VM from among the one or more VM deletion candidates.

In Operation 306, and as discussed above in reference to FIG. 2 (e.g., as part of VM incident creation process 207 of FIG. 2), an incident ticket (or incident workflow) may be generated for starting (e.g., triggering) deletion of the at least one to-be-deleted-VM.

In Operation 308, and as discussed above in reference to FIG. 2, a data processing system hosting the at least one to-be-deleted-VM may be caused (e.g., by itself or by a data processing system manager) to delete the at least one to-be-deleted-VM from the data processing system.

The process may end following operation 308.

In embodiments, the one or more VM deletion candidates (discussed in Operation 302) may be powered-off VMs that are still hosted on and take up limited computing resources of the data processing system despite being in a shutdown state. Deletion of any one of these one or more VM deletion candidates may advantageously free up (unnecessarily) tied up limited computing resources of the data processing system. As a direct result of the (unnecessarily) tied up limited computing resources of the data processing system being freed up, the computer functionalities of the data processing system (e.g., the data processing system's memory space, the data processing system's ability to run/host any remaining VMs and other applications and/or services, or the like) may be improved since the (unnecessarily) tied up limited computing resources of the data processing system are now freed up to be used and/or allocated for other (maybe more critical and/or useful for a user of the data processing system at that point in time) functions of the data processing system.

Any of the components illustrated in FIGS. 1A-3 may be implemented with one or more computing devices. Turning to FIG. 4, a block diagram illustrating an example of a computing device (also referred to herein as “system 400”) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system-on-a-chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth® transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing virtual machines (VMs), the method comprising:
obtaining VM data associated with the VMs;
using the VM data to identify one or more VM deletion candidates;
performing a VM importance determination process to identify at least one to-be-deleted-VM from among the one or more VM deletion candidates;
generating an incident ticket for starting deletion of the at least one to-be-deleted-VM; and
causing, based on the incident ticket, a data processing system hosting the at least one to-be-deleted-VM to delete the at least one to-be-deleted-VM from the data processing system.

2. The method of claim 1, wherein the one or more VM deletion candidates are powered-off VMs that are still hosted on and take up limited computing resources of the data processing system despite being in a shutdown state.

3. The method of claim 2, wherein the one or more VM deletion candidates are powered-off VMs that have been in the shutdown state for over a predetermined shutdown time threshold.

4. The method of claim 1, wherein performing the VM importance determination process comprises:
generating a VM deletion score for each of the one or more VM deletion candidates, the VM deletion score being based on a degree of importance of each of the one or more VM deletion candidates.

5. The method of claim 4, wherein the may be an inference generated a combination of machine learning based techniques comprising bagging, boosting, and stacking.

6. The method of claim 4, wherein the degree of importance is based on an entity to which a VM deletion candidate among the one or more VM deletion candidates is assigned.

7. The method of claim 6, wherein the degree of importance is further based on a time of creation of the VM deletion candidate.

8. The method of claim 7, wherein the degree of importance is further based on a determination of whether the VM deletion candidate is a development VM or a production VM.

9. The method of claim 8, wherein the degree of importance is further based on a technology purpose for which the VM deletion candidate is being used.

10. The method of claim 1, wherein the deleting of the at least one to-be-deleted-VM is completed without taking a snapshot of the at least one to-be-deleted-VM during or before the deleting.

11. The method of claim 1, wherein the method is performed by a data processing system manager that manages a plurality of the data processing system where each of the plurality of the data processing system hosts one or more of the VMs, and the method being performed by the data processing system manager fully automatically without any intervention by any users of the data processing system manager and any users of the plurality of the data processing system.

12. The method of claim 1, further comprising:
obtaining, from the data processing system and in response to the data processing system being caused to delete the at least one to-be-deleted-VM, a VM deletion failure notification indicating that deletion of the at least one to-be-deleted-VM has failed and requires manual intervention by a user; and
forwarding the VM deletion failure notification to the user to request manual deletion by the user.

13. A non-transitory machine-readable medium having instructions stored therein, which when executed by a processor, cause the processor to perform operations for managing virtual machines (VMs), the operations comprising:
obtaining VM data associated with the VMs;
using the VM data to identify one or more VM deletion candidates;
performing a VM importance determination process to identify at least one to-be-deleted-VM from among the one or more VM deletion candidates;
generating an incident ticket for starting deletion of the at least one to-be-deleted-VM; and
causing, based on the incident ticket, a data processing system hosting the at least one to-be-deleted-VM to delete the at least one to-be-deleted-VM from the data processing system.

14. The non-transitory machine-readable medium of claim 13, wherein the one or more VM deletion candidates are powered-off VMs that are still hosted on and take up limited computing resources of the data processing system despite being in a shutdown state.

15. The non-transitory machine-readable medium of claim 14, wherein the one or more VM deletion candidates are powered-off VMs that have been in the shutdown state for over a predetermined shutdown time threshold.

16. The non-transitory machine-readable medium of claim 13, wherein performing the VM importance determination process comprises:
generating a VM deletion score for each of the one or more VM deletion candidates, the VM deletion score being based on a degree of importance of each of the one or more VM deletion candidates.

17. A data processing system, comprising:
a processor; and
a memory coupled to the processor to store instructions, which when executed by the processor, cause the processor to perform operations for managing virtual machines (VMs), the operations comprising:
obtaining VM data associated with the VMs;
using the VM data to identify one or more VM deletion candidates;
performing a VM importance determination process to identify at least one to-be-deleted-VM from among the one or more VM deletion candidates;
generating an incident ticket for starting deletion of the at least one to-be-deleted-VM; and
causing, based on the incident ticket, a data processing system hosting the at least one to-be-deleted-VM to delete the at least one to-be-deleted-VM from the data processing system.

18. The data processing system of claim 17, wherein the one or more VM deletion candidates are powered-off VMs that are still hosted on and take up limited computing resources of the data processing system despite being in a shutdown state.

19. The data processing system of claim 18, wherein the one or more VM deletion candidates are powered-off VMs that have been in the shutdown state for over a predetermined shutdown time threshold.

20. The data processing system of claim 17, wherein performing the VM importance determination process comprises:
generating a VM deletion score for each of the one or more VM deletion candidates, the VM deletion score being based on a degree of importance of each of the one or more VM deletion candidates.
